(19) United States
(12) Patent Application Publication
(10) Pub. No.: US 2002/0183053 A1
(43) Pub. Date: Dec. 5, 2002

(54) Methods and systems for testing macrodiversity and handover functionality of a radio network controller

(76) Inventors: Muralimohan Gopalakrishna, Morrisville, NC (US); Pierre Joseph Lynch, Morrisville, NC (US)

Correspondence Address: JENKINS & WILSON, PA, 3100 TOWER BLVD, SUITE 1400, DURHAM, NC, 27707, US

(21) Appl. No.: 09/866,955

(22) Filed: May 29, 2001

(51) Int. Cl. H04B 17/00

(52) U.S. Cl. 455/423; 455/424; 455/67.1; 455/67.4

(57) ABSTRACT

Methods and systems for testing macrodiversity and handover functionality of an RNC are disclosed. An RNC test system is capable of simulating both node B and user equipment functionality. The RNC test system is also capable of simulating multiple node B instances. The RNC test system allows the user to set signal quality parameters in messages sent to the RNC to simulate weak or erroneous signals received from user equipment. In response, the RNC instructs the RNC to add radio links or switch between previously established radio links. The RNC test system also simulates dynamic radio link addition and deletion in response to messages received from the RNC.

### TECHNICAL FIELD

The present invention relates to macrodiversity in a mobile communications network. More particularly, the present invention relates to methods and systems for testing macrodiversity and handover functionality of a radio network controller in a mobile communications network.

### BACKGROUND ART

Macrodiversity refers the establishment of redundant radio connections between a mobile terminal and the fixed network to enhance radio performance in mobile communications networks. In the uplink direction, i.e., from the mobile terminal towards the radio network controller, the signals are combined by fixed network nodes and sent to the intended recipient. In the downlink direction, i.e., from the radio network controller towards the mobile terminal, a fixed network element splits a signal into redundant radio channels, sends the signal over the redundant channels to the mobile terminal and the mobile terminal combines the signals.

A mobile communications network function that relates to macrodiversity is handover. Handover refers to the switching that occurs at a base station from one radio channel to another radio channel caused by differences in signal strength between the radio channels. For example, if signal strength on one radio channel is below a threshold and signal strength on another radio channel is above a threshold, a base station may ignore signals on the first channel and process only signals received on the second channel. The differences in signal strength between radio channels may be caused by a change in geographic location of a mobile terminal relative to the antennas at the base station(s) with which the radio channels are established.

There are three types of handovers that occur in mobile communications networks—hard handover, soft handover, and softer handover. A hard handover is a switch from one radio channel to another radio channel that has not been previously established. A soft handover is a switch from one radio channel to another previously established radio channel, i.e., make before break, where the two radio channels are with different base stations. A softer handover refers to a switch from one radio channel to another previously established radio channel where the two radio channels are with the same base station. A softer handover may occur when a mobile terminal moves between areas served by different antennas of a base station.

With the advent of third generation mobile communications networks, such as universal mobile telecommunications (UMTS) networks, new network elements and protocols have been introduced. These new network elements and protocols are used in performing the above-mentioned macrodiversity and handover functions. FIG. 1 is a block diagram illustrating an exemplary UMTS network, including entities involved in macrodiversity and handover functions. In FIG. 1, user equipment 100 comprises a mobile telephone terminal. Node Bs 102 are the base stations that communicate with user equipment over the air interface. Radio network controllers (RNCs) 104 are switches that route messages between node Bs 102 and core network 106. Core network 106 includes network elements, such as media gateways and media gateway controllers, that set up and control packet-based media communications between end users. Core network 106 is not involved in macrodiversity and handover functions and hence will not be described further herein. Dashed line 107 encompasses the components of the universal terrestrial radio access network (UTRAN) in which embodiments of the present invention may operate.

The interface between node Bs 104 and RNCs 106 is referred to as the lub interface. The interface between RNCs 104 and core network 106 is referred to as the lu interface. The interface between RNCs is referred to as the lur interface. The interface between RNCs 104 and core network 106 is referred to as the lu interface.

In the illustrated example, multiple radio paths are established between user equipment 100 and node Bs 102 in order to provide macrodiversity, soft handovers, and softer handovers. RNCs 104 control the establishment of these separate radio paths using the lub interface. Because RNCs control macrodiversity and handover functions, it is desirable to have efficient methods and system for testing RNCs before placing RNCs in a live network. More particularly, it is desirable to have efficient methods and systems for testing the macrodiversity and handover functionality of an RNC.

Testing the macrodiversity and handover functionality of an RNC can be difficult because it requires that the test system simulate both node B and user equipment functionality. In addition, the test system may be required to simulate multiple node B instances for the case when a mobile terminal is communicating with multiple base stations. Conventional test systems are incapable of simulating multiple node B instances and/or of simulating node B and mobile handset functionality. Accordingly, there exists a long felt need for methods and systems for testing the macrodiversity and handover functionality of an RNC that are capable of node B and user equipment simulation, as well as multiple node B simulation.

### DISCLOSURE OF THE INVENTION

According to one aspect, the present invention includes a system for testing macrodiversity and handover functionality of an RNC. The system includes a plurality of modules for simulating user equipment functionality and node B functionality in order to trigger a macrodiversity or handover function at an RNC. In one embodiment, the system communicates with the RNC to establish a simulated call. The call is initially set up over a single radio path. The system then sends signal quality parameters indicating that the signal quality associated with the simulated call is below a threshold value. The signal quality parameters trigger the RNC to communicate with the system to establish a new radio path for the simulated call. In the uplink direction, the system sends data simulating the multiple radio paths to the RNC. In the downlink direction, the system receives data sent over multiple lub interface connections from the RNC and combines the data from the multiple connections. In addition to triggering macrodiversity functions at the RNC, the test system triggers the RNC to perform soft, softer, and hard handovers.

According to another aspect, the present invention includes an RNC test system that simulates node B and user equipment functionality and that is capable of simulating multiple node B instances. The test system includes a first link interface controller for simulating a first node B instance. A second link interface controller simulates a second node B instance. A diversity handover controller controls communication between the first and second node B instances and a radio network controller.

Accordingly, it is an object of the present invention to provide methods and systems for testing the macrodiversity and handover functionality of an RNC.

It is another object of the invention to provide a test system capable of simulating node B and UE functionality and multiple node B instances.

Some of the objects of the invention having been stated hereinabove, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings, of which:

FIG. 1 is a block diagram of a third generation mobile communications network illustrating the macrodiversity and handover functionality of an RNC;

FIG. 2 is a block diagram illustrating a system for testing the macrodiversity and handover functionality of an RNC in a mobile communications network according to an embodiment of the present invention;

FIG. 3 is a flow chart illustrating exemplary steps that may be performed by an RNC test system in testing the macrodiversity and handover functionality of an RNC according to an embodiment of the present invention;

FIG. 4 is a block diagram illustrating the internal architecture of an RNC test system according to an embodiment of the present invention;

FIGS. 5A-5D are a call flow diagram illustrating exemplary steps for dynamic radio link addition and call origination simulated by an RNC test system according to an embodiment of the present invention;

FIGS. 6A-6D are a call flow diagram illustration exemplary steps for dynamic radio link addition at a called destination that may be simulated by an RNC test system according to an embodiment of the present invention;

FIG. 7 is a call flow diagram illustrating exemplary steps for dynamic radio link deletion that may be simulated by an RNC test system according to an embodiment of the present invention; and

FIGS. 8A-8C are a call flow diagram illustration exemplary steps for call termination that may be simulated by an RNC test system according to an embodiment of the present invention.

### DETAILED DESCRIPTION OF THE INVENTION

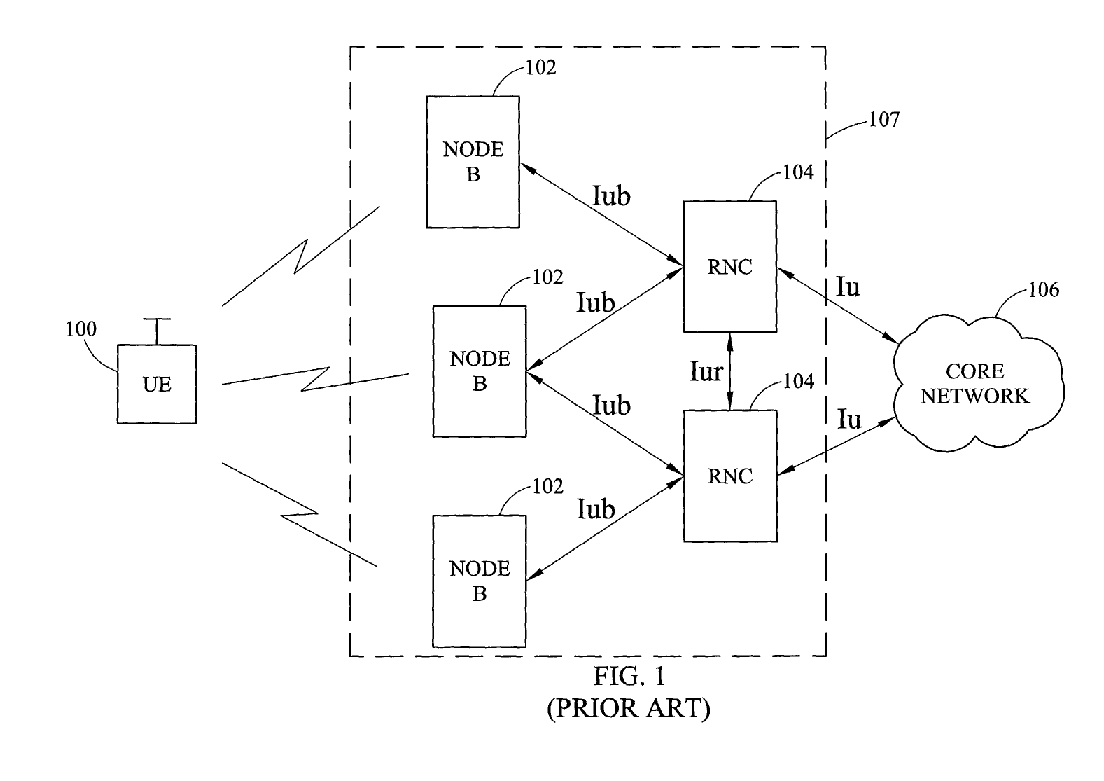

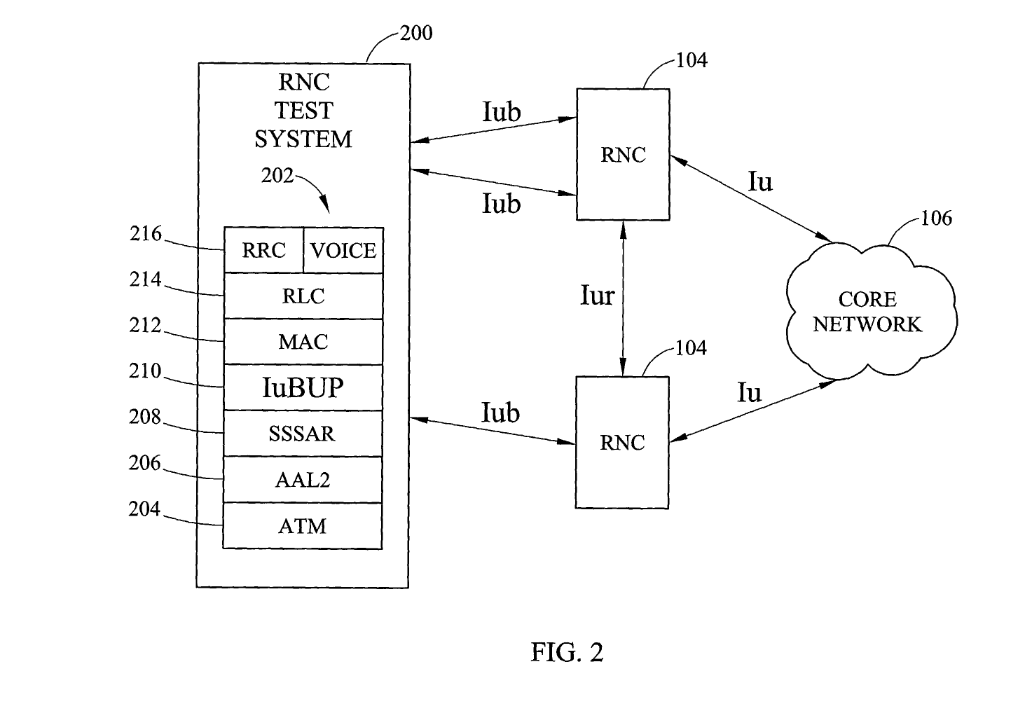

FIG. 2 illustrates a radio network controller test system according to an embodiment of the present invention. In the illustrated embodiment, radio network controller test system 200 communicates with multiple RNCs 104 to trigger and monitor macrodiversity and handover functions of RNCs 104. Radio network controller test system 200 simulates the functionality of both node Bs 102 and user equipment 100 (illustrated in FIG. 1) in order to test the macrodiversity and handover functionality of an RNC. In one exemplary embodiment, radio network controller test system implements multiple instances of protocol stack 202 in order to simulate macrodiversity and handover functionality for a voice call. Each instance of protocol stack 202 simulates a node B and is referred to herein as a node B instance. Protocol stack 202 includes an ATM layer 204, which transmits and receives information in 53-byte units, referred to as cells, over VPI/VCI connections. ATM adaptation layer 2 206 encapsulates variable-length packets, such as compressed voice packets, into 48-byte ATM cells at the source of a transmission and unencapsulates these packets at the destination of a transmission. SSSAR layer 208 performs segmentation and reassembly functions for transmitted and received data units.

According to an important aspect of the invention, radio network controller test system 200 simulates lub interface user plane (luBUP) layer 210. The luBUP protocol is described in Universal Mobile Telecommunications System (UMTS); UTRAN lub/lur Interfaces User Plane Protocol for DCH Data Streams (3GPP TS 25.427 version 3.5.0 Release 1999) and Universal Mobile Telecommunications System (UMTS); UTRAN lub Interface User Plane Protocols for Common Transport Channel Data Streams (3GPP TS 25.435 version 3.5.0 Release 1999), the disclosures of each of which are incorporated herein by reference in their entirety. Layer 210 can be used by a node B to indicate the quality of a signal received from user equipment to an RNC. For example, lub user plane layer 210 may periodically send frames to RNCs 104 including signal quality information for the air interface channels managed by a node B. RNCs 104 utilize this information to determine when to instruct a node B to establish new radio paths with user equipment for macrodiversity purposes and when to switch between radio paths.

In a preferred embodiment of the invention, the information that triggers macrodiversity and handover functionality at RNCs 104 is included in the lub interface user plane protocol cyclical redundancy code indicator (CRCI) and quality estimate (QE) parameters. Using these parameters, radio network controller test system 200 triggers functionality in RNCs 104 to instruct node Bs to establish a new radio channel with a mobile handset or to switch between communication channels with the mobile handset. Radio network controller test system 200 may monitor the messages received from RNCs 104 to determine whether the RNC correctly instructed the node B instance or instances simulated by test system 200 to add new radio links, switch between existing radio links, etc. Test system 200 preferably also responds to messages received from the RNC to actually perform the requested handover and/or macrodiversity functions. Thus, radio network controller test system 200 according to an embodiment of the present invention is capable of triggering and monitoring macrodiversity and handover functionality in an RNC.

Medium access control (MAC) layer 212 controls access to the underlying AAL2 and ATM layers. The medium access control layer is described in Universal Mobile Telecommunications System (UMTS); MAC Protocol Specification (3GPP TS 25.321 version 3.6.0 Release 1999), the disclosure of which is incorporated herein by reference in its entirety. Radio link control (RLC) layer 214 segments PDUs received from higher layers and delivers the PDUs to MAC layer 212. The RLC layer is described in Universal Mobile Telecommunications System (UMTS), RLC Protocol Specification (3GPP TS 25.322 version 3.5.0 Release 1999), the disclosure of which is incorporated herein by reference in its entirety. RLC layer 214 also reassembles PDUs received from MAC layer 212 into RLC PDUs. RRC portion of layer 216 controls the establishment and release of radio bearer channels, controls the establishment of RRC connections between user equipment and the network, and controls the establishment, maintenance, and release of resources associated with the RRC connection. The radio resource control protocol is defined in Universal Mobile Telecommunications System (UMTS); RRC Protocol Specification (3GPP TS 25.331 version 3.5.0 Release 1999), the disclosure of which is incorporated herein by reference in its entirety. Finally, the voice portion of layer 216 carries user information. Radio network controller test system 200 simulates each of these layers when testing the macrodiversity and handover functionality of an RNC, as will be discussed in detail below.

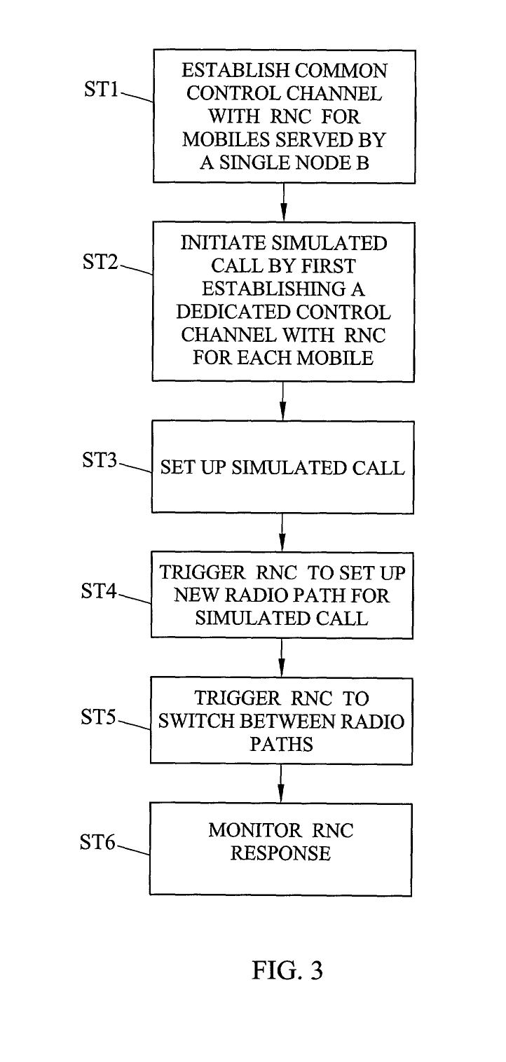

FIG. 3 is a flow chart illustrating exemplary steps performed by radio network controller test system 200 in testing the macrodiversity and handover functionality of an RNC according to an embodiment of the present invention. Referring to FIG. 3, in step ST1, radio network controller test system 200 establishes a simulated common control channel with an RNC 104. This simulated common control channel is a common channel for all mobile terminals served by a single node B. The simulated common control channel is allocated by the RNC through radio resource control (RRC) and node B application part (NBAP) signaling. The NBAP protocol is defined in Universal Mobile Telecommunications System (UMTS); UTRAN lub Interface NBAP Signaling (3GPP TS 25.433 version 3.4.1 Release 1999), the disclosure of which is incorporated herein by reference in its entirety.

In step ST2, radio network controller test system 200 initiates a simulated call by first establishing a dedicated control channel for the call. In order to request the dedicated control channel, radio network controller test system 200 simulates RRC signaling by the mobile over the previously-established common control channel. RNC 104 allocates the dedicated control channel via the NBAP, Q.AAL2, and RRC protocols. Q.AAL2 is an International Telecommunications Union protocol used to set up an AAL2 connection. Radio network controller test system 200 simulates the messages generated by the mobile handset and the node B in establishing the dedicated control channel. The dedicated control channel is specific to a single mobile handset.

In step ST3, radio network controller test system 200 sets up a simulated call. First, RNC 104 first sets up a user plane for the call by creating a dedicated traffic channel using the lub user plane protocol. Non-access stratum signaling is then employed to go through the traditional call setup steps with the network (setup, connect, confirm, etc.). Once the call setup is complete, a simulated call is in progress between radio network controller test system 200 and another node, which may also be simulated by test system 200, through RNC 104. The call initially goes through a single node B and has a single radio path.

In step ST4, radio network controller test system 200 triggers RNC 104 to instruct a node B instance simulated by radio network controller test system 200 to set up new radio paths for the call. In third generation mobile communication networks, a new radio path may be established when the signal from an original radio path is indicated to the RNC to be weak or erroneous. One mechanism for communicating radio signal quality to the RNC is through the lub/lur interface user plane protocol CRC indicator (CRCI) and quality estimate (QE) parameters. The CRCI parameter is a CRC code that indicates the correctness of transport blocks received at the node B from the user equipment. The CRCI is a one bit code. If the transport block is correct, the value is set to zero. If the value is incorrect, the value is set to 1. The QE parameter is a parameter in an lub/lur user plane protocol uplink frame. The QE parameter is an eight-bit quantity ranging in value from 1 to 255 that indicates the bit error rate of the transport channel between the node B and the mobile handset.

Since the CRCI and QE parameters can be used to communicate signal quality information to the RNC, they can also be used by radio network controller test system 200 to trigger macrodiversity and/or handover functionality at the RNC. The QE and CRCI parameters may be periodically communicated to the RNC in lub user plane protocol frames. RNC test system 200 according to an embodiment of the present invention allows the user to select arbitrary values for the QE and CRCI parameters. This allows the user to simulate a weak or erroneous signal on the radio path.

In a UMTS network, RNCs may periodically send update request messages to node Bs. In parallel with the communication of the CRCI and QE parameters to the RNC, a node B may respond to an RNC update request for all mobile signals being received by the node B. If a mobile terminal has changed geographic locations, the node Bs may respond that a signal from the same mobile is being received in a new cell on the same node B or by a different node B. When this is recognized, the RNC allocates new radio paths in the same way that an initial radio path was created.

Once multiple radio paths are established, it may be desirable to test whether a radio network controller correctly instructs the node B to switch between radio paths. Accordingly, in step ST5, radio network controller test system 200 triggers the RNC to cause a node B to switch between radio paths, i.e., to perform a handover. Triggering a handover cover may be accomplished in a similar manner to triggering macrodiversity, i.e., by communicating signal quality parameters to the RNC that indicate low signal strength on one radio channel. If it is desired to trigger a soft handover, RNC test system 200 may simulate two node B instances, originate a call, and add a radio link for each node B instance. The test system may then send quality parameters to the RNC indicating a weak or erroneous signal on one of the radio links and a strong or error free signal on the other radio link. In order to trigger a softer handover, RNC test system 200 may simulate one node B instance, simulate a call with the network and add two radio links for the node B instance. Test system 200 may then send signal quality parameters to the RNC simulating a weak or erroneous signal on one of the radio links and a strong or error free signal on the other radio link. In order to trigger a hard handover, RNC test system 200 may simulate two node B instances, simulate a call between user equipment and the network and establish a single radio link for the call. Test system 200 may then communicate signal quality parameters to the RNC simulating a weak or erroneous signal on the radio link and indicate to the RNC that the UE has moved into an area serviced by the second node B instance. In response, the RNC instructs test system 200 to perform a hard handover. Test system 200 does so by deleting the first radio link and adding a new radio link with the second node B instance. As stated above, the signal quality parameters used to trigger macrodiversity and handover functionality may be the lub user plane CRCI and QE parameters. Using these parameters RNC test system 200 can test macrodiversity, hard handover, soft handover, and softer handover functionality of an RNC.

The present invention is not limited to using the CRCI and QE parameters to trigger macrodiversity and handover functions in an RNC. Utilizing any parameter recognizable by an RNC to determine when to establish multiple radio paths or to instruct a node B to switch between radio paths is intended to be within the scope of the invention. For example, in an alternate embodiment of the invention, test system 200 may send RRC measurement report messages to the RNC to indicate signal quality on downlink signal received by UE simulated by RNC 200. In UMTS networks, RNCs may send measurement control messages to user equipment to instruct the user equipment to send measurement report messages when predefined events occur. Exemplary events that may trigger measurement report messages include receiving a predefined number of messages on the downlink channel with bad CRCs, received signal strength falling below a threshold value, received signal strength reaching a UE receiver's dynamic range, etc. RNC test system 200 allows the user to simulate any one or more of these events to test the response of the RNC.

Once test system 200 simulates the user-specified event or parameter, in step ST6, radio network controller test system 200 monitors the response received by RNC. Such monitoring may include receiving and recording NBAP, RRC, and/or Q.AAL2 signaling from the RNC for establishing new radio paths or for switching between radio paths. RNC test system 200 may generate a report, such as a call record, indicating messages sent to and received from an RNC during a call. RNC test system 200 may also respond to instructions from the RNC to add, delete, and switch between radio paths.

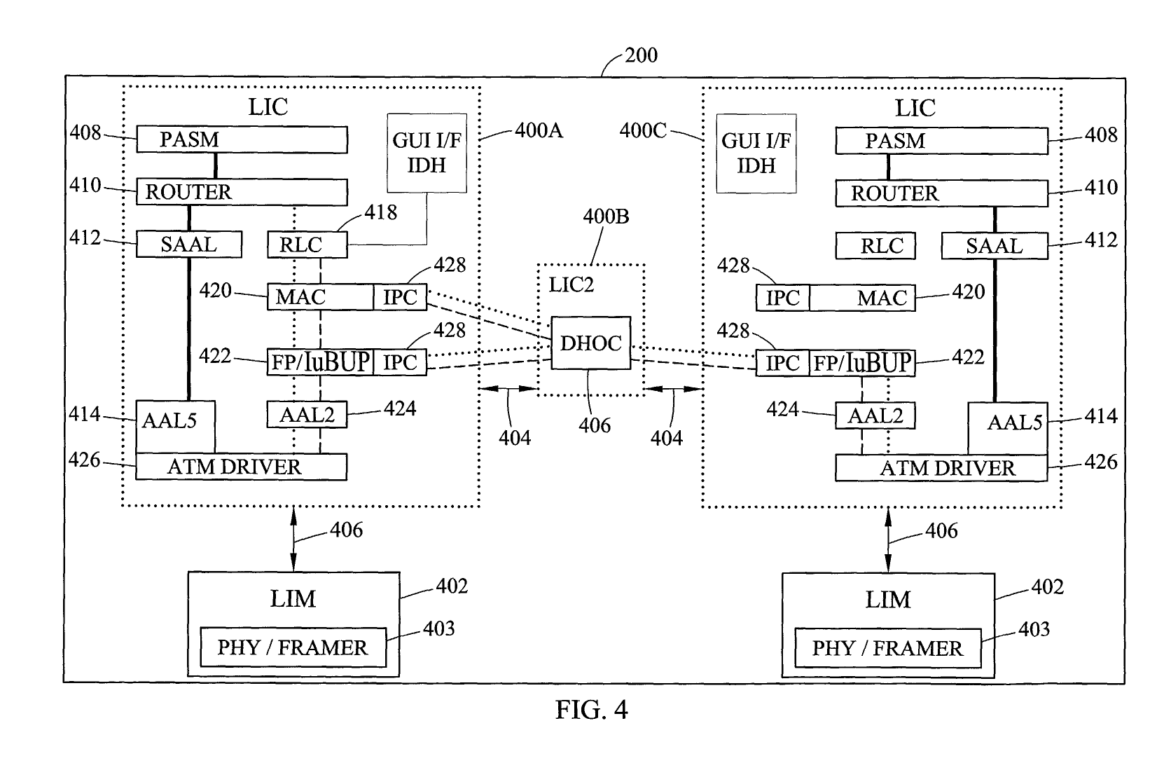

FIG. 4 is a block diagram illustrating an exemplary internal architecture for radio network controller test system 200. In FIG. 4, radio network controller test system 200 includes a plurality of link interface controllers (LICs) 400A-400C and a plurality of link interface modules (LIMs) 402. Link interface controllers 400 and link interface modules 402 comprise printed circuit boards with processors and associated memory mounted thereon. In particular, link interface controllers 400A-C include general purpose microprocessors for generating simulated traffic and processing traffic received from a device under test, such as an RNC. Link interface modules 402 include special purpose processors 403 for communicating over a particular physical interface, such as an electrical interface or an optical interface. In a preferred embodiment of the invention, special purpose processors 403 comprise PHY/framer chips for communicating over a particular electrical or optical interface, such as a SONET interface, an SDH interface, a T1 interface, or an E1 interface. Link interface controllers 400 are connected via inter-LIC communications bus 404. Similarly, each LIM 402 is connected to its associated LIC 404 via a communications bus 406. In a preferred embodiment, buses 404 and 406 may each comprise compact personal computer interface (PCI) buses.

In order to test the macrodiversity and handover functions of an RNC, LIC 400A simulates a first node B instance and LIC 400C simulates a second node B instance. One of LICs 400A and 400C preferably also simulates user equipment. In the illustrated embodiment, LIC 400A simulates user equipment in addition to a node B instance. LIC 400B includes a diversity handover controller (DHOC) 406 for combining data received over multiple radio paths from an RNC in the downlink direction and sending the combined data to the LIC that simulates the user equipment. Combining data may be performed based on signal quality parameters, such as QE or CRCI values in the data received from the RNC. In the uplink direction, diversity handover controller receives data from the LIC that simulates the user equipment, splits the data into multiple radio paths, and forwards the data to the node B instances simulated by LICs 400A and 400C to be transmitted to the RNC over multiple radio links. Splitting the data into multiple radio paths may include setting different signal quality for each of the radio paths to trigger handover or macrodiversity functions by the RNC, as discussed above.

The present invention is not limited to simulating two node B instances in a single test system. Any number of LICs and LIMs may be provisioned in a test system to simulate any number of node B instances and user equipment functionality. In addition, the present invention is not limited to simulating a call that only involves a single RNC. Test system 200 allows the user to test the functionality of multiple RNCs, if desired, using the steps described herein for testing a single RNC.

LICs 400A and 400C each include various protocol layer functions and user interfaces. For example, each LIC includes a protocol adaptable state machine (PASM) 408 that allows a user to create test cases for testing the network elements such as a radio network controller. Routers 410 route user defined messages received from PASM 408 to the appropriate lower layer protocol stack. One of the lower layer protocol stacks includes signaling ATM adaptation layer (SAAL) 412 and ATM adaptation layer 5 (AAL5) 414. This protocol stack is designed to carry control signaling packets between network elements. The other protocol stack includes RLC layer 418, MAC layer 420, FP/luBUP layer, 422, and AAL2 layer 424. This protocol stack is designed to carry variable length voice packets. Both protocol stacks share an ATM driver 426 that sends and receives ATM cells over VPI/VCI connections.

The operation of RNC test system 200 in establishing multiple node B instances to test the macrodiversity and handover functions of an RNC will now be described in more detail. According to the present invention inter-layer messages referred to as primitives are utilized to internally configure RNC test system 200 for macrodiversity and handover simulation. The examples discussed below illustrate primitives and network protocol messages to dynamically add radio links, dynamically delete radio links, establish calls, and terminate calls simulated by test system 200.

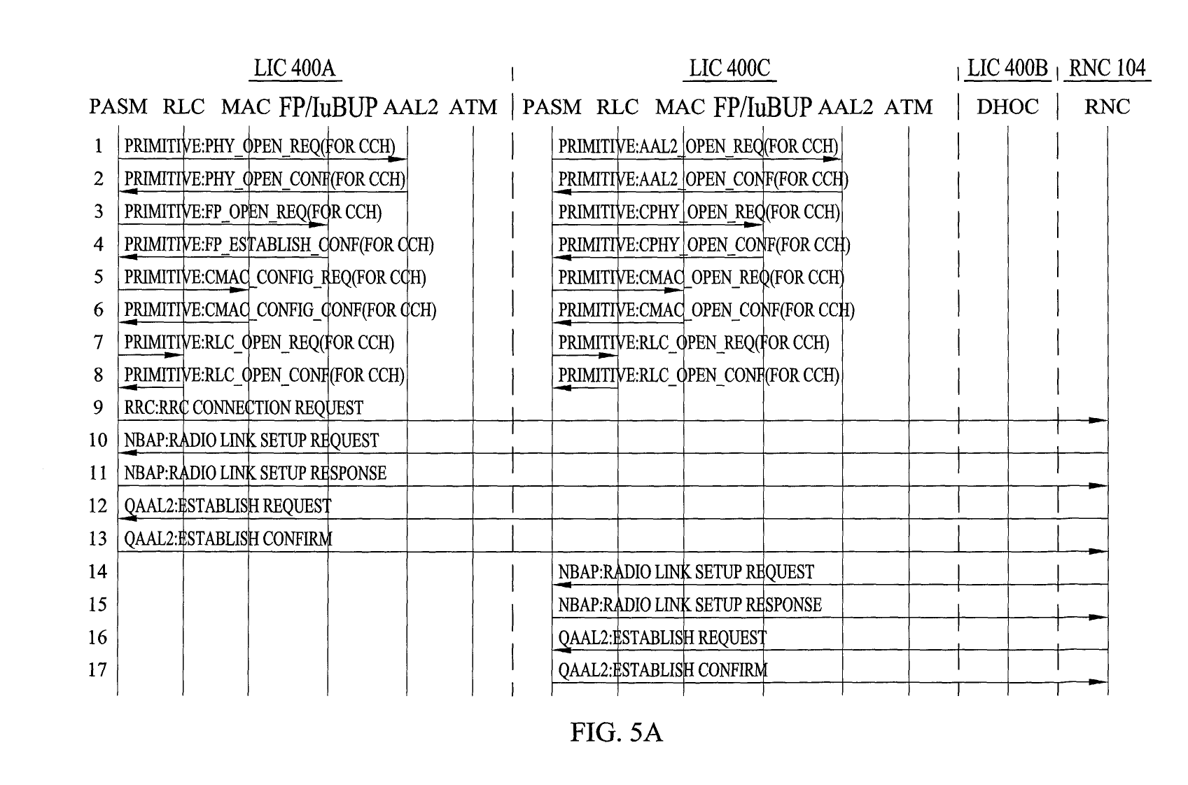

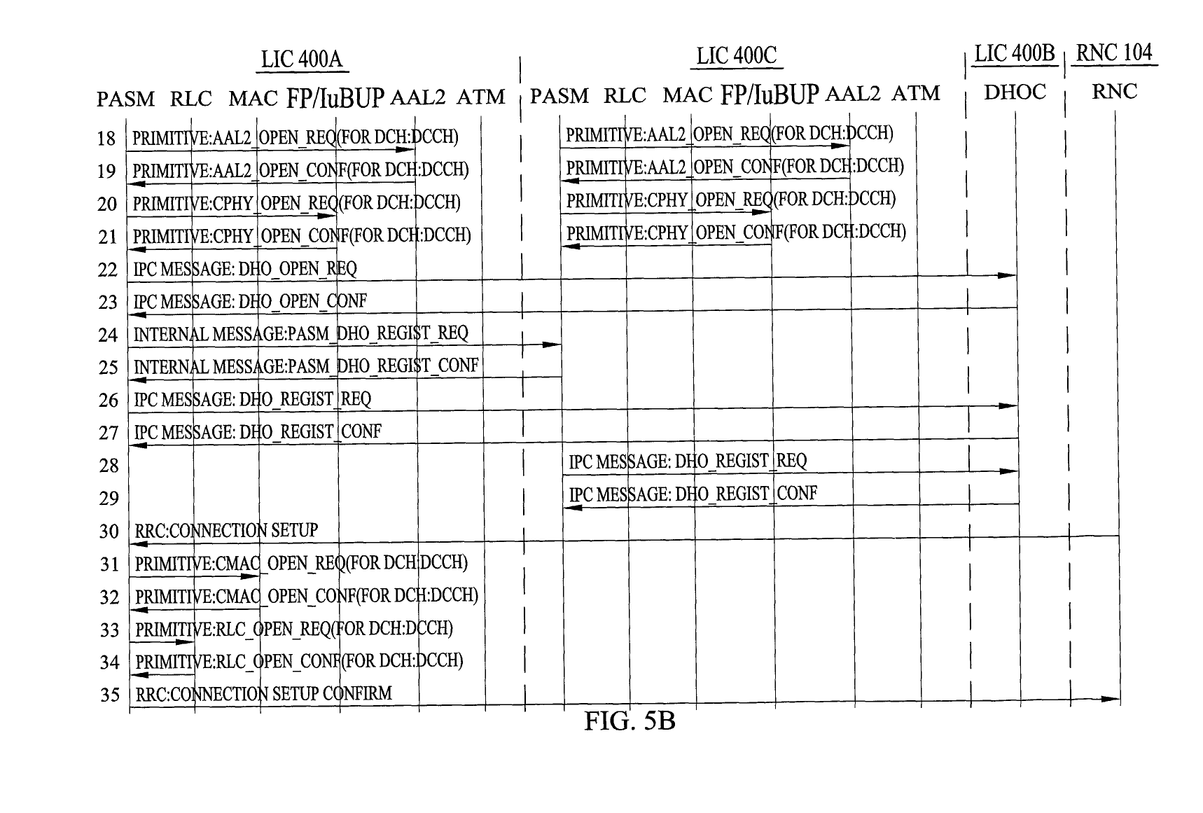

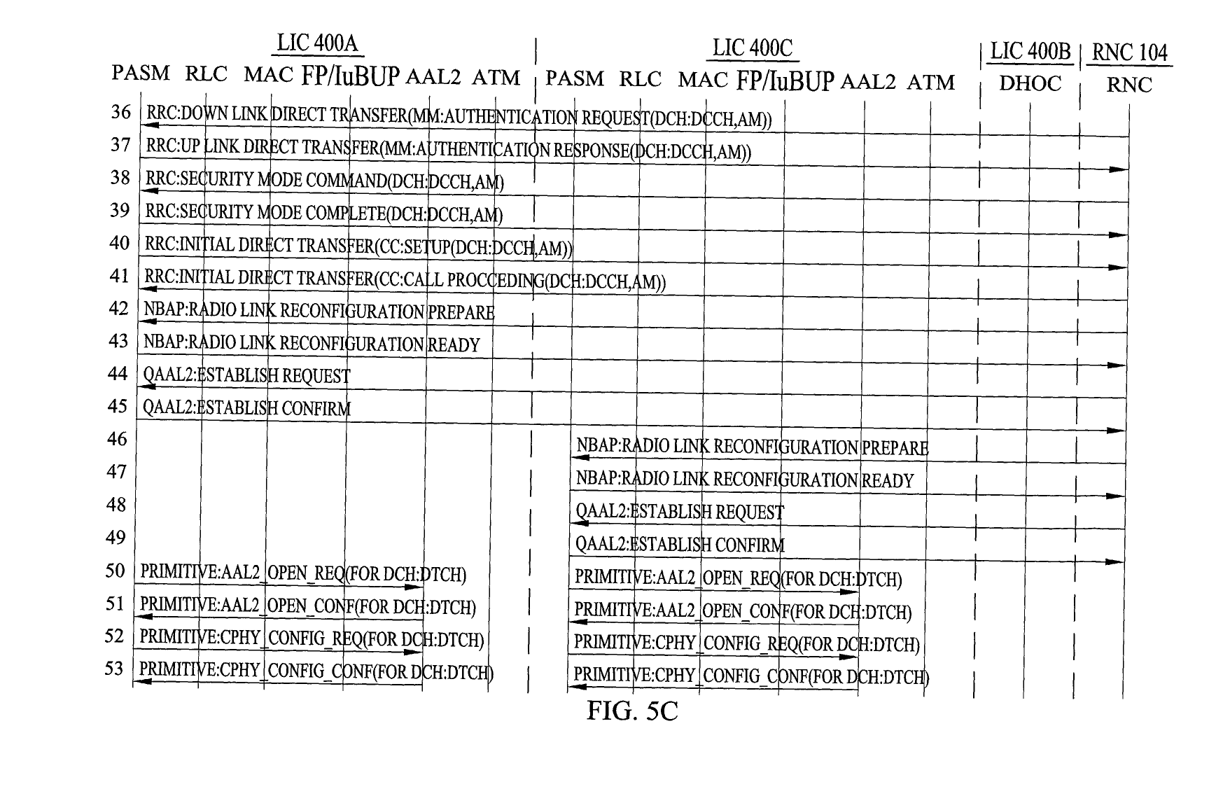

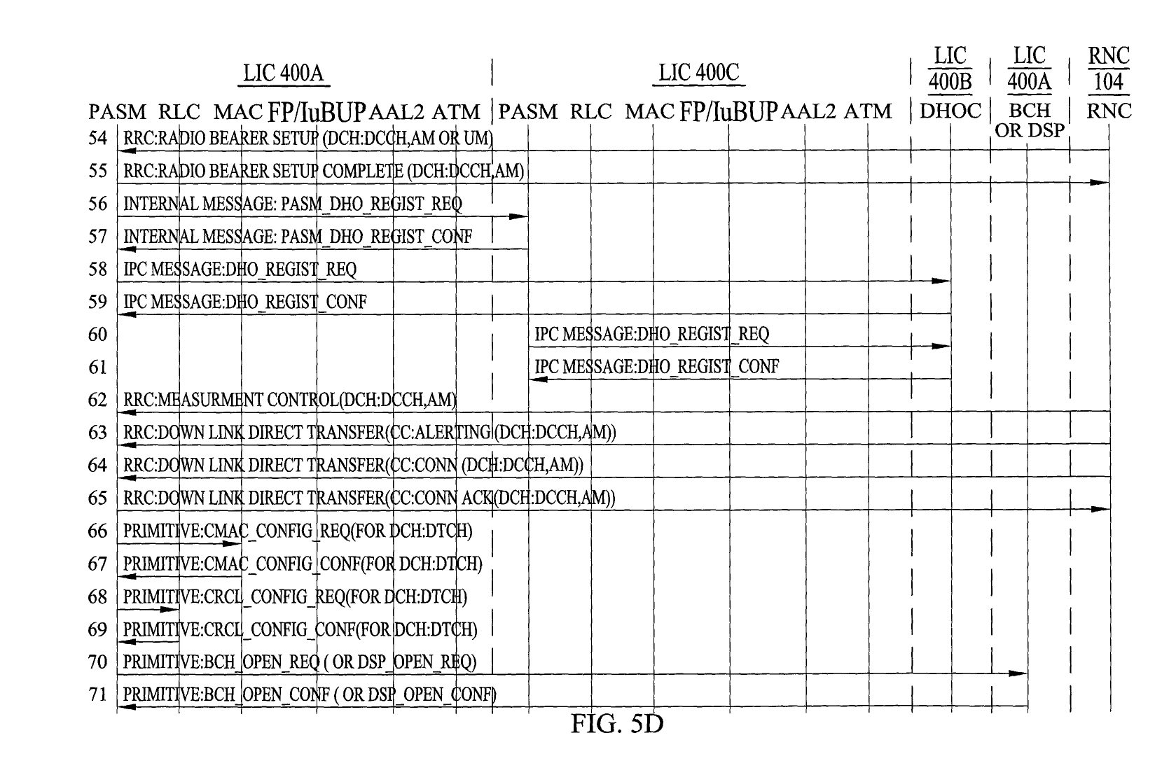

FIGS. 5A-5D are a call flow diagram illustrating call origination and dynamic radio link addition functions performed by RNC test system 200 according to an embodiment of the present invention. In lines 1 and 2 of the call flow diagram, PASM 408 and AAL2 424 running on LICs 400A and 400C exchange primitives for opening an AAL2 connection for the common control channel (CCH). In lines 3 and 4 of the call flow diagram, PASM 408 and FP/luBUP layer 422 on LICs 400A and 400C exchange primitives for opening an FP/luBUP connection for the common control channel. In lines 5 and 6, PASM 408 and MAC layer 420 on LICs 400A and 400C exchange primitives for configuring the MAC layer for the common control channel. In lines 7 and 8 of the call flow diagram, PASM 408 and RLC layer 418 on LICs 400A and 400C exchange primitives for configuring the RLC layer for the common control channel. In lines 9-17 of the call flow diagram, PASMs 408 on LICs 400A and 400B establish a common control channel connection with RNC 104 via RRC, NBAP, and Q.AAL2 signaling. Once the steps illustrated in FIG. 5A are complete, common control channels are established between LICs 400A and 400C and RNC 104.

Once the common control channels are set up with the RNC, it is necessary to set up a dedicated control channel and dedicated bearer channel between each node B instance and the RNC. The steps required to set up these channels are illustrated in FIG. 5B. Referring to FIG. 5B, in lines 18 and 19 of the call flow diagram, PASMs 408 and ML2 layers 424 exchange primitives for establishing an AAL2 connection for the DCH:DCCH channel. In lines 20 and 21 of the call flow diagram, PASMs 408 and FP/luBUP layers 422 on LICs 400A and 400C exchange primitives for establishing an FP/luBUP connection for the DCH:DCCH channel.

In order to perform macrodiversity and handover, functions, a diversity handover controller (DHOC) instance must be created and each LIC must register with the DHOC instance so that messages to and from the RNC will pass through the DHOC instance, which performs diversity handover functions, such as selection and recombination of signals. Accordingly, in lines 22 and 23 of the call flow diagram, PASM 408 on LIC 400A exchanges interprocessor communication (IPC) messages with LIC 400B to establish a DHOC instance 406. In lines 24 and 25 of the call flow diagram, PASM 408 on LIC 400A notifies PASM 408 on LIC 400B of the creation of DHOC instance 406. In lines 26-29 of the call flow diagram, PASMs 408 of LICs 400A and 400C register with the DHOC instance 406 on LIC 400B. Once the node B instances simulated by LICs 400A and 400C have registered with DHOC instance 406 on LIC 400B, all communications to and from PASMs 408 and RNC 104 will pass through DHOC instance 406.

In line 30 of the call flow diagram, PASM 408 on LIC 400A receives an RRC connection setup message from RNC 104. An RNC connection setup message instructs the node B instance executing on LIC 400A to establish an RRC connection for a UE. In response to the RRC connection setup message, in lines 31 and 32 of the call flow diagram, PASM 408 on LIC 400A exchanges primitives with MAC layer 420 on LIC 400A to open a MAC connection for the DCH:DCCH channel. In lines 33 and 34 of the call flow diagram, PASM 408 on LIC 400A and RLC layer 418 on LIC 400A exchange primitives for opening an RLC connection for the DCH:DCCH channel. In line 35 of the call flow diagram, PASM 408 on LIC 400A sends an RRC connection confirm message to RNC 104 to confirm the establishment of the RRC connection between the UE instance simulated by LIC 400A and RNC 104.

Referring to FIG. 5C, in lines 36-39 of the call flow diagram, PASM 408 on LIC 400A and RNC 104 exchange authentication messages for the DCH:DCCH channel. In lines 40 and 41 of the call flow diagram, PASM 408 on LIC 400A and RNC 104 exchange call setup and call proceeding messages to set up a call between the UE simulated by LIC 400A and the network. In lines 42 and 43 of the call flow diagram, PASM 408 on LIC 400A and RNC 104 exchange NBAP signaling to establish a radio link for the simulated call. In lines 44 and 45 of the call flow diagram, PASM 408 and RNC 104 exchange Q.AAL2 messages to set up an AAL2 connection for the simulated call. In lines 46-49 of the call flow diagram, PASM 408 on LIC 400C and RNC 104 exchange NBAP and Q.AAL2 messages to setup NBAP and Q.AAL2 messages to set up a radio link and an AAL2 connection between the node B instance simulated by LIC 400C and RNC 104 for the simulated call.

In lines 50 and 51 of the call flow diagram, PASMs 408 and AAL2 layers 424 on LICs 400A and 400C exchange primitives for opening an AAL2 connection for the DCH:DTCH channel. In lines 52 and 53 of the call flow diagram, PASMs 408 and FP/luBUP layers 422 on LICs 400A and 400C exchange primitives for opening an FP connection for the DCH:DTCH channel.

Referring to FIG. 5D, in lines 54 and 55 of the call flow diagram, PASM 408 of LIC 400A and RNC 104 exchange RRC messages to establish a bearer channel for the simulated call. In lines 56 and 57 of the call flow diagram, PASM 408 of LIC 400A exchanges DHO registration messages with PASM 408 of LIC 400C. In lines 58 and 59 of the call flow diagram, PASM 408 of LIC 400A registers with DHOC instance 406 on LIC 400B for bearer channel communications. In lines 60 and 61 of the call flow diagram, DHOC instance 406 on LIC 400C communicates with PASM 408 on LIC 400B to register the bearer channel with LIC 400C.

In line 62 of the call flow diagram, RNC 104 sends an RRC measurement control message to PASM 408 on LIC 400A. The purpose of the RRC measurement control message is to request a measurement to be performed by the UE simulated by LIC 400A. In line 63 of the call flow diagram, RNC 104 sends a downlink direct transfer message containing an alerting message. The purpose of this message is to indicate to the UE that the called party is being alerted of the incoming call. In line 64 of the call flow diagram, RNC 104 transmits a downlink direct transfer message containing a connect message to indicate that that the called party has answered the call by going off hook. In line 65 of the call flow diagram, PASM 408 of LIC 400A acknowledges the connect message by sending a connect message in an RRC downlink direct transfer message to the RNC.

In lines 66 and 67 of the call flow diagram, PASM 408 of LIC 400A exchanges configuration request primitives with MAC layer 420 of LIC 400A for the DCH:DTCH channel. In lines 68 and 69 of the call flow diagram, PASM 408 of LIC 400A exchanges primitives with RLC layer 418 of LIC 400A in order to configure a radio link for the DCH:DTCH channel. In lines 70 and 71, PASM 408 of LIC 400A exchanges primitives with a bearer channel application, which may also be resident on LIC 400A in order to open the bearer channel connection between the bearer channel application and the lower protocol layers.

Once the steps illustrated in FIGS. 5A-5D are completed, a simulated call with two radio links is in progress between test system 200 and a called destination. LIC 400A simulates user equipment and a first node B instance. LIC 400C simulates a second node B instances. LIC 400B copies packets received from the UE instance running on LIC 400A and sends copies of the packets to RNC 104 through LICs 400A and 400C to simulate multiple radio paths in the uplink direction. In the downlink direction, DHO instance receives packets from the RNC through FP/luBUP layers of LICs 400A and 400C, selects the packets on the path having the best signal quality, and forwards the best packets to the UE simulation executing on LIC 400A. Thus, FIGS. 5A-5D illustrate that test system 200 is capable of simulating call origination, multiple node B instances and dynamic radio link addition.

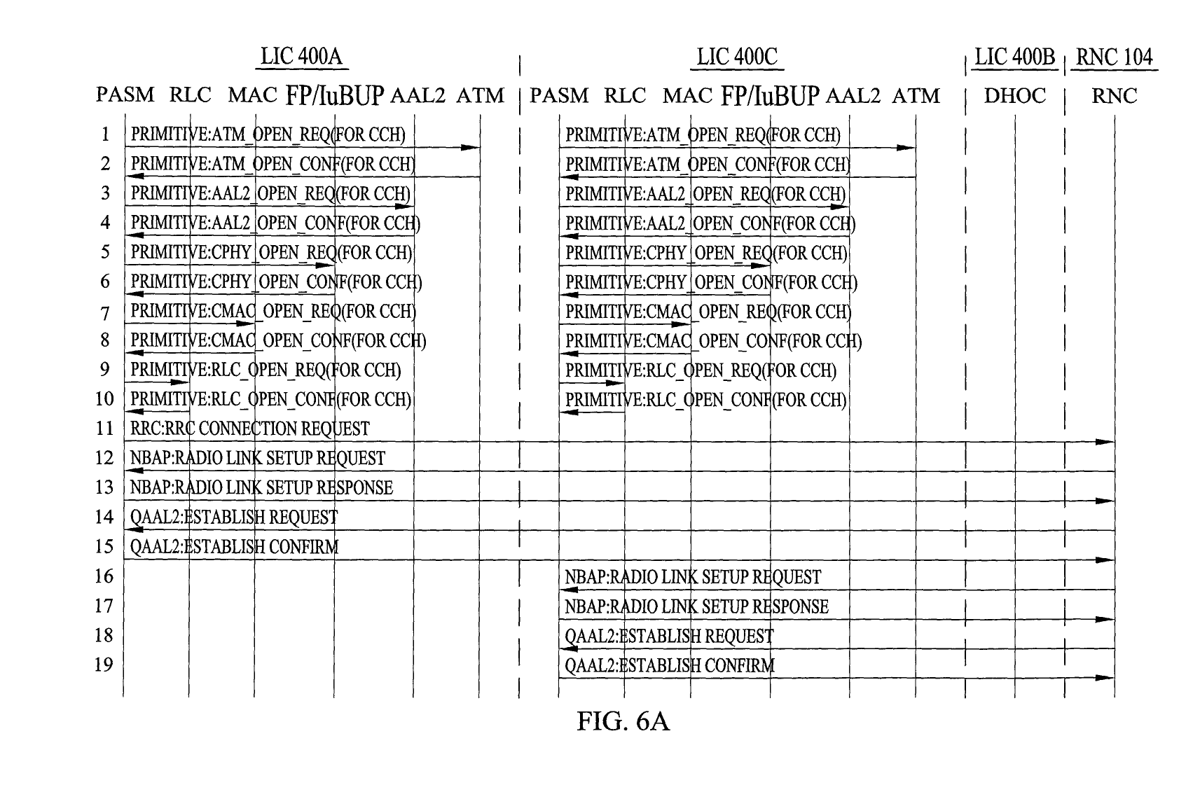

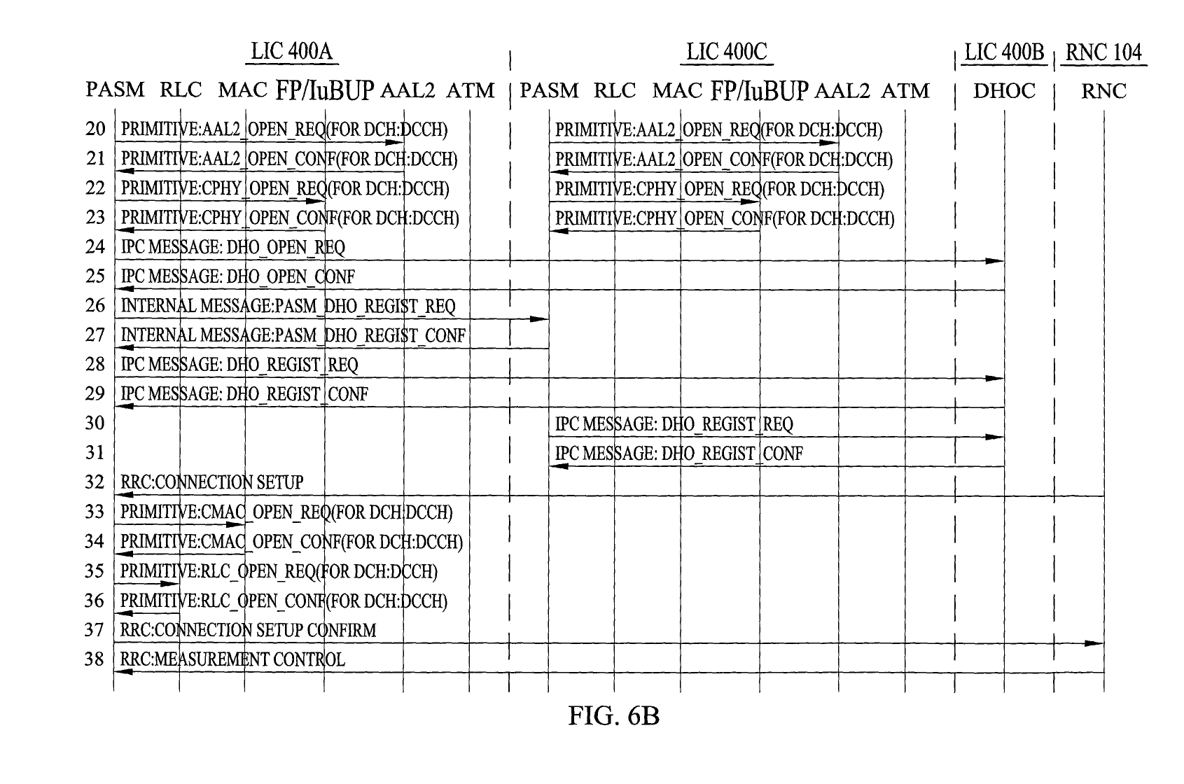

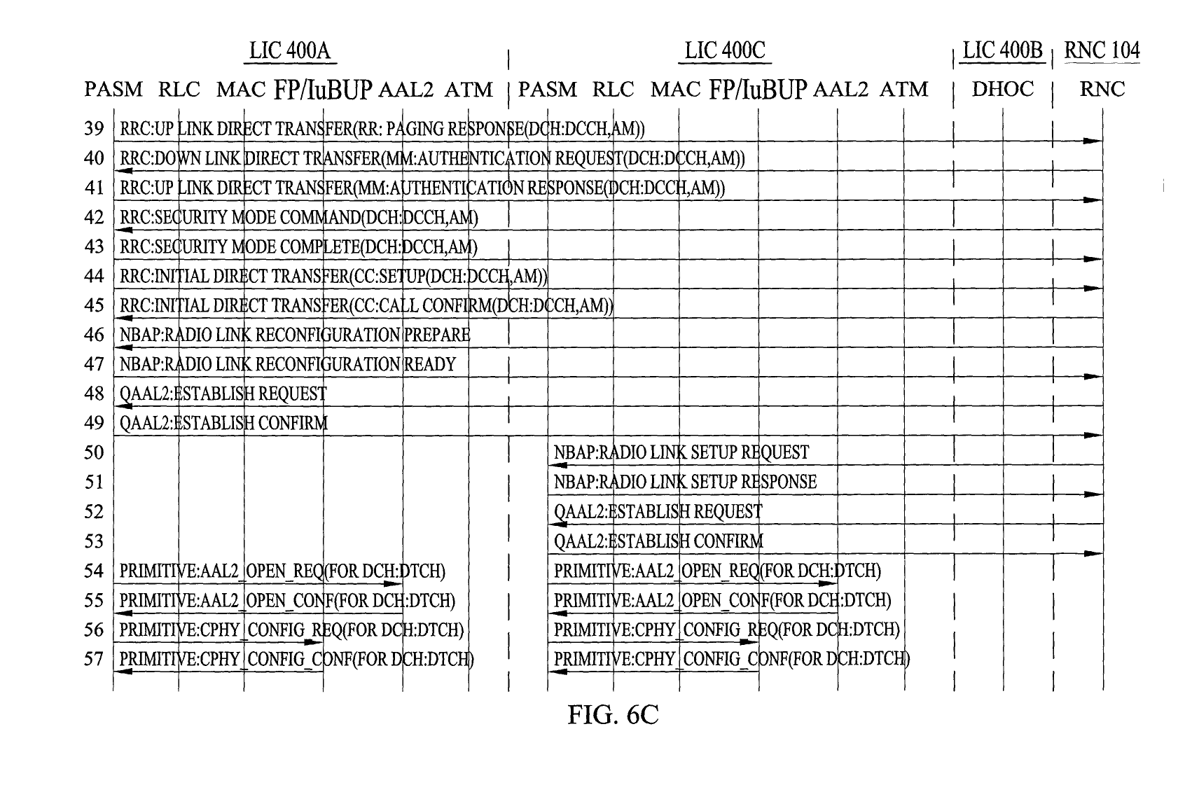

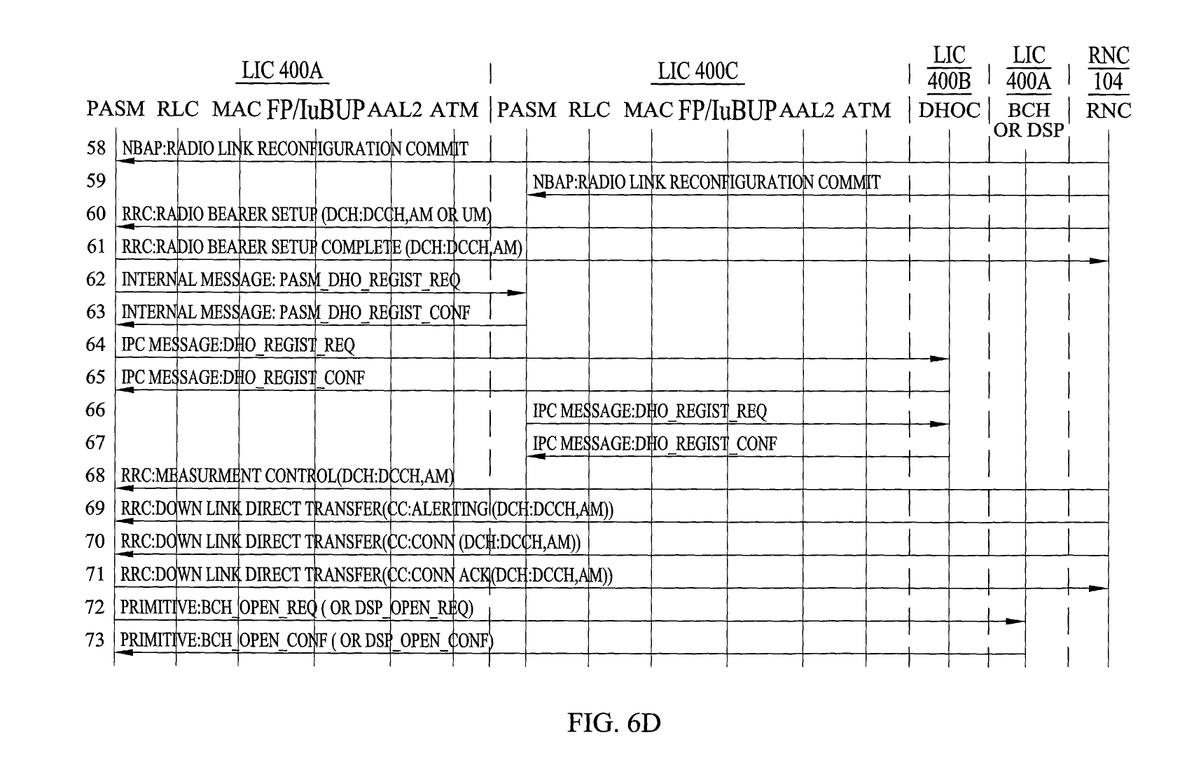

FIGS. 6A-6D are a call flow diagram illustrating steps performed by test system 200 in simulating multiple node B instances and performing radio link addition in real time when test system 200 simulates the destination of a call. Referring to FIG. 6A, in lines 1 and 2, PASMs 408 and ATM drivers 426 of LICs 400A and 400C exchange primitives to open an ATM connection for opening a common channel between the node B instances simulated by LICs 400A and 400C and RNC 104. In lines 3 and 4, PASMs 408 and AAL2 layers 424 of LICs 400A and 400C exchange primitives for opening an ML2 connection for the common channel. In lines 5 and 6 of the call flow diagram, PASMs 408 and FP/luBUP layers 422 of LICs 400A and 400B exchange primitives to establish an FP communication for the common channel. In lines 7 and 8 of the call flow diagram, PASMs 408 and MAC layers 420 of LICs 400A and 400C exchange primitives for establishing MAC layer connections for the incoming common channel. In lines 9 and 10 of the call flow diagram, PASMs 408 and RLC layers 418 of LICs 400A and 400C exchange primitives for establishing RLC communications for the incoming common channel.

In lines 11-15 of the call flow diagram, PASM 408 of LIC 400A communicates with RNC 104 to establish a connection for the common channel via RRC, NBAP, and Q.AAL2 signaling. In lines 16-19 of the call flow diagram, PASM 408 of LIC 400C communicates with RNC 104 to establish a radio link with its node B instance via NBAP and Q.AAL2 signaling.

Referring to FIG. 6B, in lines 20 and 21, PASMs 408 and AAL2 layers 424 of LICs 400A and 400C exchange primitives for establishing an AAL2 connection for the DCH:DCCH channel. In lines 22 and 23, PASMs 408 and FP/luBUP layers 422 of LICs 400A and 400C exchange primitives for opening an FP connection for the DCH:DCCH channel. In lines 24 and 25, PASM 408 of LIC 400B registers with DHOC 406 executing on LIC 400B. In lines 26 and 27, PASM 408 of LIC 400A instructs PASM 408 of LIC 400B to register with DHOC 406 of LIC 400B. In lines 28-31 of the call flow diagram, PASMs 408 of LICs 400A and 400C register with DHOC 406. Once both PASMs have registered with DHOC 406, all communications to and from LICs 400A and 400C will pass through DHOC 406.

In line 32 of the call flow diagram, PASM 408 of LIC 400A receives an RRC connection setup message for the incoming call. In lines 33 and 34 of the call flow diagram, PASM 408 of LIC 400A exchanges primitives with MAC layer 420 of LIC 400A to open a MAC connection for the DCH:DCCH channel associated with the incoming call. In lines 35 and 36 of the call flow diagram, PASM 408 of LIC 400A exchanges primitives with RLC layer 418 of LIC 400A to open an RLC connection for the DCH:DCCH channel associated with the incoming call. In line 37 of the call flow diagram, PASM 408 of LIC 400A sends a connection setup confirm message to RNC 104 to confirm the completion of internal procedures required to set up the connection for the incoming call. In line 38 of the call flow diagram, RNC 104 transmits an RRC measurement control message to PASM 408 of LIC 408 to initiate periodic measurements from the UE simulated by LIC 400A.

Referring to FIG. 6C, in line 39 of the call flow diagram, PASM 408 of LIC 400A sends an RRC uplink direct transfer message to RNC 104 containing a paging response message. The paging response message indicates to the source of the call that the called party is being notified of the incoming call. In lines 40 and 41 of the call flow diagram, PASM 408 of LIC 400A receives and responds to an authentication request message from RNC 104. In lines 42 and 43 of the call flow diagram, PASM 408 of LIC 400A and RNC 104 exchange security parameters for the DCH:DCCH channel. In line 44 of the call flow diagram, PASM 408 of LIC 400A sends and RRC initial direct transfer message including a setup message for the incoming call. In line 45 of the call flow diagram, RNC 104 sends a setup confirm message to PASM 408 of LIC 400A to confirm the setup of the call.

In lines 46 and 47 of the call flow diagram, RNC 104 and PASM 408 of LIC 400A exchange NBAP messages for configuring a radio link for the incoming call. In lines 48 and 49 of the call flow diagram, RNC 104 and PASM 408 of LIC 400A exchange Q.AAL2 messages for establishing an AAL2 connection for the incoming call. In lines 50 and 51 of the call flow diagram, RNC 104 and PASM 408 of LIC 400C exchange NBAP messages for setting up a radio link between the node B instance simulated by LIC 400C and the RNC for the incoming call. In lines 52 and 53 of the call flow diagram, RNC 104 and PASM 408 of LIC 400C exchange Q.AAL2 messages for establishing a Q.AAL2 connection between the node B instance simulated by LIC 400C and the incoming call. In lines 54 and 55 of the call flow diagram, PASMs 408 and AAL2 layers 424 of LICs 400A and 400C exchange primitives for opening an AAL2 connection for the DCH:DTCH channel for the incoming call. In lines 56 and 57 of the call flow diagram, PASMs 408 and FP/luBUP layers 422 of LICs 400A and 400B exchange primitives for establishing an FP/luBUP connection for the DCH:DTCH channel associated with the incoming call.

Referring to FIG. 6D, in lines 58 and 59 of the call flow diagram, RNC 104 sends NBAP radio link reconfiguration commit messages to PASMs 408 of LICs 400A and 400C. In line 60 of the call flow diagram, RNC 104 sends an RRC bearer setup message to PASM 408 of LIC 400A. In line 61 of the call flow diagram, PASM 408 of LIC 400A confirms setup of the bearer channel by sending an RRC radio bearer setup complete message to RNC 104. In lines 62 and 63 of the call flow diagram, PASMs 408 of LICs 400A and 400C exchange PASM DHO registration request and confirmation messages. In lines 64 and 65 of the call flow diagram, PASM 408 of LIC 400A registers with DHOC for the bearer channel. In lines 66 and 67 of the call flow diagram, PASM 408 of LIC 400C registers with DHC 400B for its bearer channel communications. In line 68 of the call flow diagram, RNC 104 sends an RRC measurement control message to PASM 408 of LIC 400A. In line 69 of the call flow diagram, RNC 104 transmits an RRC downlink direct transfer message containing an alerting message to PASM 408 of LIC 400A. The alerting message indicates that a ring back tone is being played to the calling party. In line 70 of the call flow diagram, RRC 104 sends an RRC downlink direct transfer message to PASM 408 of LIC 400A indicating that a connection has been established between the called and calling parties. In line 71 of the call flow diagram, PASM 408 of LIC 400A transmits a connecting acknowledgement message acknowledging the connection. In lines 72 and 73 of the call flow diagram, PASM 408 of LIC 400A exchanges primitives with a B channel application, which may also execute on LIC 400A, for opening a bearer channel for the connection. Once the bearer channel is open, a call is in progress between the calling party and the called party simulated by LIC 400A. Thus, FIGS. 6A-6D illustrate steps performed by RNC test system 200 for simulating dynamic radio link addition at a called destination.

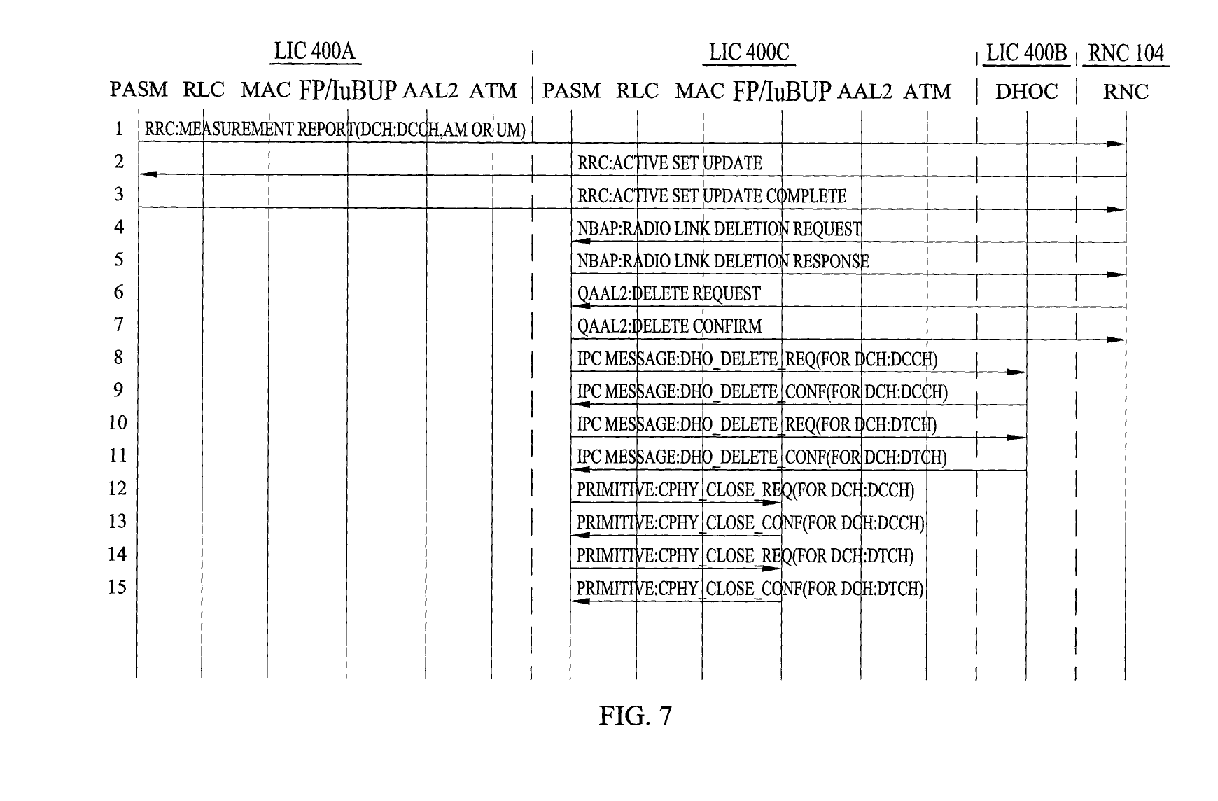

FIG. 7 illustrates the signaling between an RNC test system according to an embodiment of the present invention and an RNC in order to simulate dynamic radio link deletion. Referring to FIG. 7, in line 1 of the call flow diagram, PASM 408 of LIC 400A transmits an RRC measurement report message to RNC 104. The RRC measurement report message may indicate a weak signal on a radio link simulated by LIC 400A or LIC 400C. In lines 2 and 3 of the call flow diagram, RNC 104 and PASM 408 of LIC 400A exchange RRC messages whereby RNC 104 receives an update on the radio links managed by the node B instance simulated by LIC 400A. In lines 4 and 5 of the call flow diagram, RNC 104 and PASM 408 of LIC 400C exchange NBAP messages for deleting a radio link. In lines 6 and 7 of the call flow diagram, RNC 104 and PASM 408 of LIC 400C exchange Q.AAL2 messages for deleting the Q.AAL2 connection associated with the radio link. In lines 8 and 9 of the call flow diagram, PASM 408 of LIC 400C exchanges primitives with DHOC 406 of LIC 400B to free internal resources for the DCH:DCCH channel associated with the radio link. In lines 10 and 11 of the call flow diagram, PASM 408 of LIC 400C and DHOC 406 of LIC 400B exchange messages for deleting the DCH:DCCH channel associated with the radio link being deleted. In lines 12 and 13 of the call flow diagram, PASM 408 of LIC 400C and FP/luBUP layer of LIC 400C exchange primitives for freeing internal resources for the FP connection for the DCH:DCCH channel. In lines 14 and 15 of the call flow diagram, PASM 408 and FP/luBUP layer 422 of LIC 400C exchange primitives for freeing internal resources for the DCH:DTCH channel associated with the radio link being deleted. Once the steps in FIG. 7 have been completed, the radio link between the node B instance simulated by LIC 400C and RNC 104 is deleted. Thus, FIG. 7 illustrates steps performed by test system 200 in simulating dynamic radio link deletion.

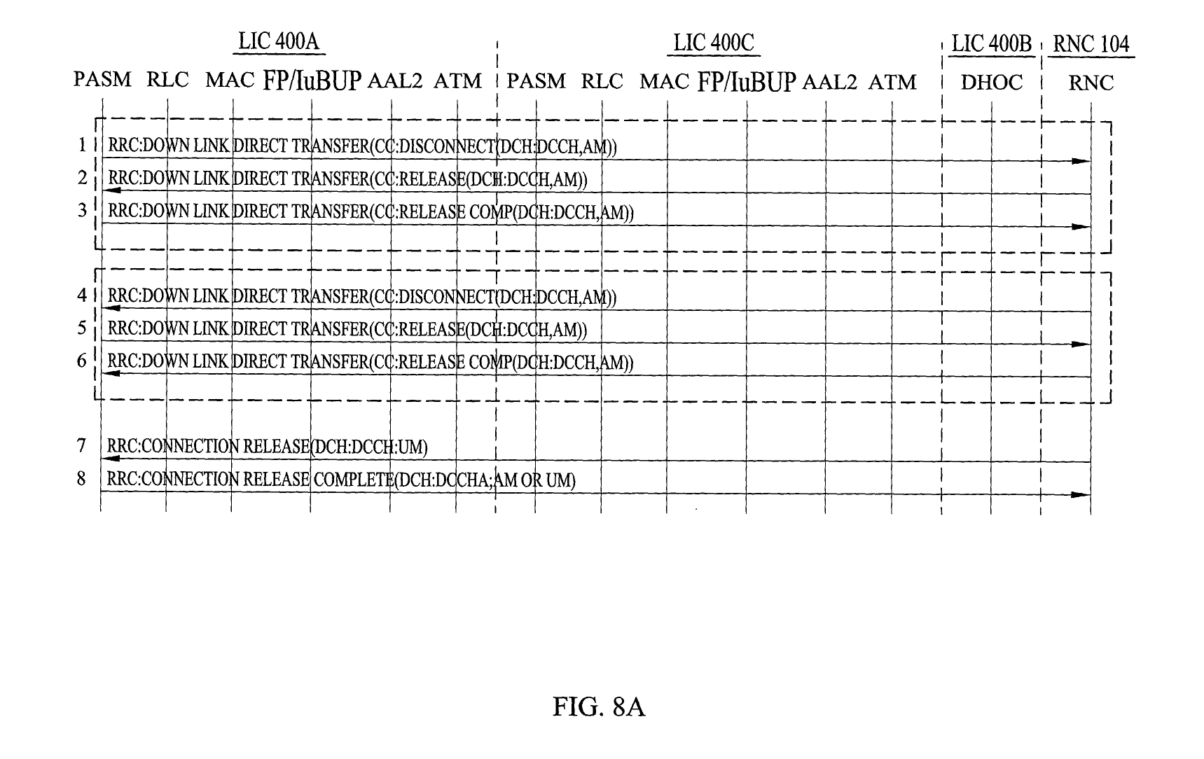

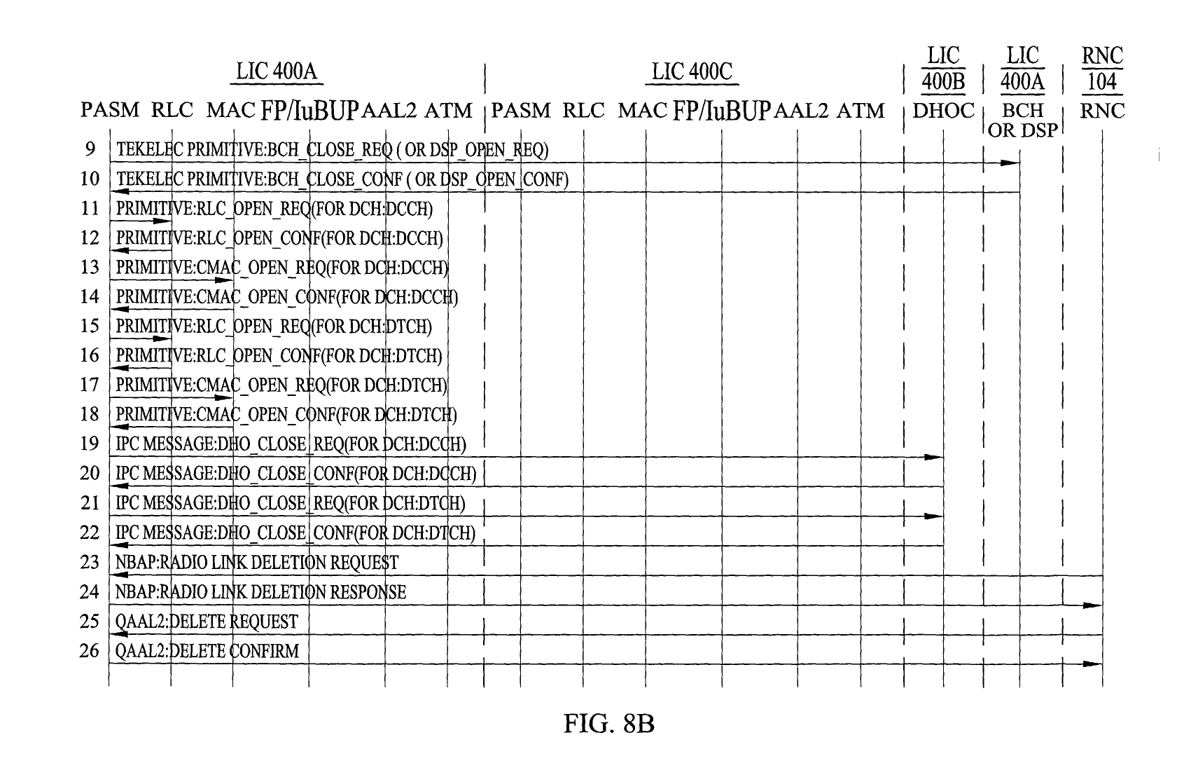

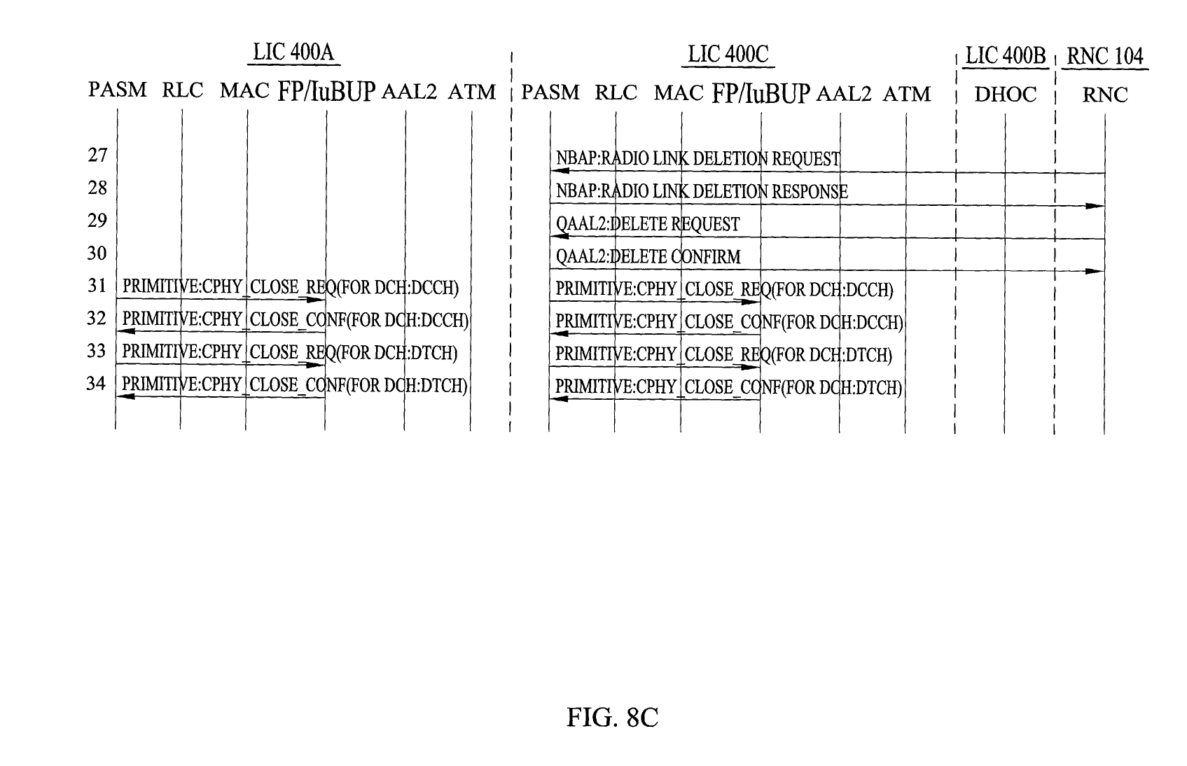

FIGS. 8A through 8C illustrate exemplary signaling between RNC test system and RNC 104 in order to simulate call termination. Referring to FIG. 8A, in lines 1 through 3 of the call flow diagram, PASM 408 of LIC 400A and RNC 104 exchange disconnect, release, and release complete messages for terminating a call between the user equipment simulated by LIC 400A and the network. In lines 4 through 6 of the call flow diagram, RNC 104 and PASM 408 of LIC 400A exchange disconnect, release, and release complete messages indicating that the other end of the call has terminated the connection. In lines 7 and 8 of the call flow diagram, RNC 104 and PASM 408 of LIC 400A exchange connection release and connection release complete messages for terminating the RRC connection associated with the call.

Referring to FIG. 8B, in lines 9 and 10 of the call flow diagram, PASM 408 of LIC 400A exchanges bearer channel close primitives with the bearer channel application to free internal resources for the bearer channel associated with the call. In lines 11 through 14 of the call flow diagram, PASM 408 of LIC 400A exchanges primitives with the appropriate layers of LIC 400A to free internal resources for the DCH:DCCH channel. In lines 15 through 18 of the call flow diagram, PASM 408 of LIC 400A exchanges primitives with the appropriate layers of LIC 400A to free internal resources for the DCH:DTCH connection associated with the call. In lines 19 and 20 of the call flow diagram, PASM 408 of LIC 400A sends messages to DHOC 406 of LIC 400B to close the diversity handover controller instance for the DCH:DCCH channel. In lines 21 and 22 of the call flow diagram, PASM 408 of LIC 400A sends messages to DHOC 406 of LIC 400B to close the DHOC instance for the DCH:DTCH channel associated with the call. In lines 23 and 24 of the call flow diagram, RNC 104 and PASM 408 of LIC 400A exchange NBAP messages to delete the radio link managed by LIC 400A. In lines 25 and 26 of the call flow diagram, RNC 104 and PASM 408 of LIC 400A exchange Q.AAL2 messages to delete Q.AAL2 resources associated with the call.

Referring to FIG. 8C, in lines 27 and 28 of the call flow diagram, RNC 104 and PASM 408 of LIC 400C exchange NBAP messages for deleting the radio link simulated by LIC 400C. In lines 29 and 30 of the call flow diagram, RNC 104 and PASM 408 of LIC 400C exchange Q.AAL2 messages to delete the AAL2 connection associated with the call. In lines 31 and 32 of the call flow diagram, PASMs 408 and FP/luBUP layers 422 of LICs 400A and 400C exchange primitives for freeing internal resources for the FP connection associated with the DCH:DCCH channel. In lines 33 and 34 of the call flow diagram, PASMs 408 and FP/luBUP layers 422 of LICs 400A and 400C exchange primitives for freeing internal resources for the DCH: DTCH connection associated with the call. Thus, by performing the steps illustrated in FIGS. 8A through 8C, RNC test system 200 according to an embodiment of the present invention is capable of simulating dynamic radio link deletion in response to a request from an RNC.

It will be understood that various details of the invention may be changed without departing from the scope of the invention. Furthermore, the foregoing description is for the purpose of illustration only, and not for the purpose of limitation the invention being defined by the claims.

What is claimed is:

1. A method for testing macrodiversity or handover functionality in a radio network controller, the method comprising:
(a) opening a simulated common control channel with a radio network controller;
(b) opening a simulated dedicated control channel with the radio network controller using the common control channel;
(c) simulating a single call having a single radio path from a mobile terminal using the dedicated control channel;
(d) triggering the radio network controller to set up an additional radio path for the call; and
(e) monitoring a response generated by the radio network controller.

2. The method of claim 1 wherein opening a common control channel includes opening a common control channel using radio resource control (RRC) and node B application part (NBAP) signaling.

3. The method of claim 1 wherein opening a dedicated control channel includes opening a dedicated control channel using node B application part (NBAP), Q.AAL2, and radio resource control (RRC) signaling.

4. The method of claim 1 wherein simulating a call includes creating a dedicated traffic channel for the first call.

5. The method of claim 4 wherein creating a dedicated traffic channel for the first call includes creating a dedicated traffic channel using the lub user plane protocol.

6. The method of claim 1 wherein triggering the radio network controller to set up an additional radio path for the call includes setting signal quality parameters in a message to simulate low signal quality from a mobile handset and sending the message to the radio network controller.

7. The method of claim 6 wherein the signal quality parameters comprise cyclical redundancy code indicator (CRCI) and quality estimate (QE) parameters.

8. The method of claim 6 wherein the message comprises an lub interface user plane (luBUP) message.

9. The method of claim 6 wherein the message comprises a radio resource control (RRC) message.

10. A method for testing a radio network controller, the method comprising:
(a) establishing first and second node B instances;
(b) establishing a simulated call between user equipment and a network using the first node B instance;
(c) receiving instructions from an RNC to add a radio link for the simulated call; and
(d) in response to the instructions, simulating dynamic addition of a radio link between the user equipment and the second node B instance.

11. The method of claim 10 wherein establishing first and second node B instances includes establishing asynchronous transfer mode (ATM), ATM adaptation layer (ML), medium access control (MAC), frame protocol/luB interface user plane (FP/luBUP) protocol layers and protocol adaptable state machine (PASM) layers for each of the node B instances.

12. The method of claim 11 wherein the PASM layer for each node B instance sends primitives to the remaining protocol layers to establish inter-layer communications.

13. The method of claim 12 wherein receiving instructions from the RNC to add a radio link for the simulated call includes receiving radio resource control (RRC), node B application part (NBAP) and Q.AAL2 messages from the RNC.

14. The method of claim 13 wherein simulating addition of a radio link includes reserving internal resources for the new radio link and responding to the RRC, NBAP, and Q.AAL2 messages relieved from the RNC.

15. The method of claim 10 comprising receiving instructions from the RNC for deleting a radio link for the simulated call and, in response to the instructions, dynamically simulating radio link deletion.

16. The method of claim 15 wherein receiving instructions from the RNC for deleting a radio link comprises receiving radio resource control (RRC), Q.AAL2, and node B application part (NBAP) signaling and wherein dynamically simulating radio link deletion includes responding to the instructions and freeing internal resources for the deleted radio link.

17. The method of claim 10 wherein establishing a simulated call between the user equipment and the network includes establishing a simulated call wherein the user equipment is a call origination point.

18. The method of claim 10 wherein establishing a simulated call between the user equipment and the network includes establishing a simulated call wherein the user equipment is a call destination point.

19. A system for testing macrodiversity or handover functionality in a radio network controller, the system comprising:
(a) a plurality of first link interface controllers for simulating a plurality of node B instances, at least one of the first link interface controllers for simulating user equipment in addition to the node B instance; and
(b) a second link interface controller for simulating a diversity handover function, wherein the diversity handover function splits data received from the link interface controller simulating the user equipment in the uplink direction into redundant streams and combines data received over redundant streams from an RNC in the downlink direction.

20. The system of claim 19 wherein each of the first link interface controllers includes asynchronous transfer mode (ATM), ATM adaptation layer, (AAL), frame protocol/lub interface user plane (luBUP), medium access control (MAC), and radio link control (RLC) protocol layers.

21. The system of claim 20 wherein each of the first link interface controllers includes a protocol adaptable state machine (PASM) for communicating with the protocol layers via inter-layer primitives.

22. The system of claim 20 wherein the PASM is adapted to simulate dynamic radio link addition in response to instructions received from the RNC.

23. The system of claim 20 wherein the PASM is adapted to simulate dynamic radio link deletion in response to instructions received from the RNC.

24. The system of claim 19 wherein the diversity handover function combines the data received from the RNC based on signal quality parameters received from the RNC.

25. The system of claim 19 wherein the diversity handover function varies the signal quality parameters in the redundant streams transmitted to the RNC in the uplink direction in order to trigger a macrodiversity or handover function.
